(19) United States
(12) Patent Application Publication
(10) Pub. No.: US 2021/0316847 A1
(43) Pub. Date: Oct. 14, 2021

(54) An Apparatus and Method for Control of Multi-Rotor Aircraft

(71) Applicant: AEROSPACE HOLDINGS INC., Cheyenne, WY (US)

(72) Inventors: Alexandru Predonu, Ilfov Voluntari (RO); Dacian Ioan Vinereanu, UNIRII Bd. Bucharest (RO)

(73) Assignee: AEROSPACE HOLDINGS INC., Cheyenne, WY (US)

(21) Appl. No.: 17/259,648

(22) PCT Filed: Jul. 13, 2018
(86) PCT No.: PCT/EP2018/069165

§ 371 Date: Jan. 12, 2021

(51) Int. Cl. B64C 27/08; B64C 39/02

(52) U.S. Cl. CPC B64C 27/08; B64C 39/024; B64C 2201/141; B64C 2201/108; B64C 2201/024

(57) ABSTRACT

An apparatus for control of multi-rotor aircraft comprising a rotor arrangement 10 having a plurality of rotors 11, each rotor being located on a rotor arm 12. The forward and rear arms 13, 14 are extensible arms 13, 14 having rotor actuators 15 such that the rotors of the forward and rear arms are movable rotors 16. The rotor actuators 15 are configured to move movable rotors 16 relative to the other movable rotors 16 and fixed rotors 18 of the rotor arrangement 10 such that location of the centre of pressure of the rotor arrangement 10 is adjusted relative to the centre of gravity of an associated multi-rotor aircraft 17.

### FIELD OF THE INVENTION

This disclosure relates to an apparatus and method for control of multi-rotor aircraft, and in particular to an apparatus and method for improving control of multi-rotor aircraft through manipulation of the relationship between centre of pressure and centre of gravity.

### BACKGROUND OF THE DISCLOSURE

Multi-rotor aircraft (or rotary-wing aircraft) are aircraft which use more than two rotors for propulsion, their main flight characteristic being the ability of vertical take-off and landing. Unlike traditional rotary-wing aircraft (such as the helicopter), multi-rotor aircraft are equipped with a distributed electrical propulsion (DEP) system which consists of several motors which are mechanically linked to the propellers, and an electronic system which controls stability by varying the speed of the propellers. The energy source for such multi-rotor aircraft is typically electrical or chemical in nature. Multi-rotor aircraft comprise various advantages over traditional rotary-wing aircraft including the absence of transmission mechanisms for both the main and the tail rotors (gear reducers, transmission axles, and mechanical couplings) and the lack of complex mechanical systems for controlling the cyclic variable pitch. Each aircraft has a centre of gravity and a centre of pressure, the centre of pressure being the point through which the lift force of the aircraft acts. The position of the centre of gravity and the centre of pressure relative to one another determines the stability of the aircraft in flight. It is also known that the centre of gravity of a multirotor aircraft changes depending on its load (variable number of passengers, cargo, fuel, etc.), and that the position of the centre of gravity relative to the centre of pressure must always fall within allowed operational limits. This is more critical when dealing with rotary-wing aircraft than in the case of fixed wing aircraft.

A wide range of unmanned multirotor electric aircraft currently exist on the market, with uses such as military and surveillance applications, aerial photography, package delivery, etc. Usually these aircraft have a fixed centre of gravity, on account of the fact that they use electrical energy as an exclusive power source resulting in no shifting due to fuel consumption. By design, these existing solutions are not equipped to handle shifting payloads. Additional payloads such as cargo or components such as cameras, microphones, or sensors would modify the weight distribution, leading to an imbalance of the aircraft. In order to compensate, some of the rotors of these existing solutions must operate inefficiently with different thrust levels, greatly reducing the flight time, manoeuvrability, and stability of the aircraft. Different systems which address the need for an adjustable centre of gravity in multirotor electric aircraft are known, such as those which adjust the centre of gravity through the use of a balance track and sliding repositionable weights.

It is the object of the present invention to provide for adjustment of the centre of pressure relative to the centre of gravity in a multi-rotor aircraft, accounting for shifts in the centre of gravity due to fuel consumption and variable payload whilst maintaining minimal thrust variance between rotors.

### SUMMARY OF THE INVENTION

According to the invention there is provided an apparatus for control of multi-rotor aircraft comprising: at least one rotor movement means in operable engagement with at least one movable rotor of a rotor arrangement; wherein the rotor movement means is configured to move the at least one movable rotor in operable engagement therewith relative to at least one other rotor of the rotor arrangement such that the location of the centre of pressure of the rotor arrangement is adjusted relative to the centre of gravity of an associated multi-rotor aircraft.

Advantageously, the centre of pressure and centre of gravity of the aircraft may be aligned or moved to within an acceptable distance of each other by physical movement of at least one movable rotor such that a variance in thrust between rotors is not required to facilitate such alignment or movement.

Preferably, the rotors of the rotor arrangement are arranged in a rotor plane such that the axes of rotation of each of the rotors is perpendicular to the rotor plane.

Ideally, the axes of rotation of each of the rotors is generally vertical.

Ideally, movement of the movable rotors is in the rotor plane.

Preferably, the rotor plane is a horizontal rotor plane.

Preferably, the rotor arrangement comprises a plurality of rotors.

Ideally, there are multiple rotor movement means, each in operable engagement with at least one movable rotor.

Preferably, each rotor movement means is configured to move its respective at least one movable rotor relative to other movable rotors, and/or relative to at least one fixed rotor of the rotor arrangement.

Ideally, the rotor movement means is an extensible arm having a first portion in operable engagement with a movable rotor and a second portion in engagement with a multi-rotor aircraft or component thereof.

Preferably, the first portion and second portion of the extensible arm are engagable with each other in a manner which permits relative movement therebetween.

Ideally, the first portion and the second portion of the extensible arm are engagable with each other via a screw means.

Preferably, the screw means is in operable engagement with a drive means, the drive means being configured to drive axial rotation of the screw means.

Ideally, the drive means is mountable to the first portion of the extensible arm.

Preferably, the second portion of the extensible arm comprises screw engagement means attachable thereto or integratable therewith.

Ideally, the screw engagement means comprises a complimentary thread configured to receive the screw.

Preferably, the complimentary thread is configured such that rotation of the screw within the complementary thread causes movement of the first portion of the extensible arm towards or away from the second portion of the extensible arm in the axial direction of the screw.

Ideally, the direction of rotation of the screw dictates the direction of travel of the first portion of the extensible arm in relation to the second portion of the extensible arm.

Preferably, the first and/or second portions of the extensible arm comprise guide means for guiding the relative movement therebetween.

Ideally, the first and second portions of the extensible arm are configured in a telescoping arrangement such that one of the portions is movably mountable within the other portion.

Preferably, the apparatus comprises twelve rotors arranged coaxially in groups of two, each group of two being locatable on an arm.

Ideally, the arms extend from a coaxial hub and form a spaced apart arrangement.

Preferably, each arm is approximately 60 degrees from adjacent arms.

Ideally, at least one of the arms is a forward arm which projects generally forwards from the coaxial hub towards a front end of a multi-rotor aircraft to which it is attached.

Preferably, two of the arms are forward arms which project generally forwards from the coaxial hub towards a front end of a multi-rotor aircraft to which they are attached.

Ideally, at least one of the arms is a rear arm which projects generally backwards from the coaxial hub, towards a back end of a multi-rotor aircraft to which it is attached.

Preferably, two of the arms are rear arms which project generally backwards from the coaxial hub, towards a back end of a multi-rotor aircraft to which they are attached.

Ideally, the forward and rear arms comprise rotor movement means such that the rotors associated therewith are forward and rear movable rotors respectively, the remainder of the arms being arms of fixed length.

Preferably, the apparatus further comprises a control means configured to control the rotor movement means or a component thereof.

Ideally, the rotor movement means have location detection means in operable engagement therewith configurable to determine the location of the movable rotors.

Preferably, the rotors have thrust level sensors in operable engagement therewith which are configurable to measure the trust levels of the rotors.

Alternatively, the thrust level sensors are in operable engagement with drive means of the rotors.

Preferably, the drive means of the rotors are motors.

Ideally, the motors are linked by a distributed propulsion system which is configurable to distribute energy to the rotors such that the thrust of individual rotors may be varied.

Preferably, the thrust of individual rotors may be varied in order to reduce the deviation between the centre of pressure of the rotors and the centre of gravity of the multirotor aircraft to within an acceptable range.

Ideally, the variation in thrust between rotors balances the rotor arrangement where the centre of pressure of a rotary aircraft is not aligned with the centre of gravity thereof.

Preferably, the control means comprises a processor.

Ideally, the control means comprises a storage medium

Preferably, the storage medium has software storable thereon.

Preferably, the storage medium is a computer-readable medium comprising non-transitory instructions storable thereon.

Ideally, the software is executable by the processor to control the rotor movement means or a component thereof.

Preferably, the control means is in operable communication with the rotor movement means or a component thereof.

Ideally, the control means is in operable communication with the location detection means.

Preferably, the control means is in operable communication with the thrust level sensors.

Ideally, the software is configured to adjust the position of at least one of the movable rotors in response to the output of the thrust level sensors.

Preferably, the movable rotors are the front and rear movable rotors.

Preferably, the software is configured to adjust the position of at least one of the movable rotors relative to the known position(s) as provided by the location detection means.

Ideally, the software is configured to adjust the position of the movable rotors such that the thrust level of at least one rotor is adjusted by the distributed propulsion system.

Preferably, the adjustment of the thrust level of the at least one rotor by the distributed propulsion system is such that variation between the thrust level of at least two rotors is zero.

Ideally, the adjustment of the thrust level of the at least one rotor by the distributed propulsion system is such that variation between the thrust level of the front and rear rotors is zero.

Most preferably, the adjustment of the thrust level of the at least one rotor by the distributed propulsion system is such that variation between the thrust level of at least two rotors falls within an acceptable range.

Preferably, the adjustment of the thrust level of the at least one rotor by the distributed propulsion system is such that variation between the thrust level of the front and rear rotors falls within an acceptable range.

Ideally, the software is configured to adjust the position of the movable rotors such that the distance between the centre of pressure and the centre of gravity falls within an acceptable range.

Preferably, the centre of pressure and centre of gravity are misaligned by a maximum of 14%.

Ideally, the maximum distance between the centre of pressure and centre of gravity is approximately 16 centimetres.

Most ideally, the software is configured to adjust the position of the movable rotors such that the distance between the centre of pressure and the centre of gravity is zero.

Ideally, the distance between the centre of pressure and the centre of gravity is defined as the distance between the centre of pressure and the centre of gravity in the rotor plane.

Preferably, the software comprises a negative feedback control loop.

Ideally, the negative feedback control loop comprises determination of thrust variances between at least two rotors followed by small movements of at least one movable rotor in an attempt to reduce the thrust variances, followed by adjustment of thrust levels to one or more rotor to maintain correct attitude of the aircraft in response to the movement of the at least one rotor.

Preferably, the negative feedback control loop re-determines thrust variance and the process of moving the at least one rotor and adjusting the thrust levels of one or more rotor to compensate for the movement is repeated, the loop continuing until the thrust variance is within a pre-defined acceptable range.

Ideally, the multi-rotor aircraft is a passenger carrying multi-rotor aircraft.

According to a second aspect of the invention there is provided a multi-rotor aircraft comprising an apparatus for improving control, the apparatus further comprising: a rotor arrangement comprising a plurality of rotors; at least one rotor movement means in operable engagement with at least one movable rotor of the rotor arrangement; wherein the rotor movement means is configured to move the at least one movable rotor in operable engagement therewith relative to at least one other rotor of the rotor arrangement such that the location of the centre of pressure of the rotor arrangement is adjusted relative to the centre of gravity of the associated multi-rotor aircraft.

According to a third aspect, there is provided a method for controlling a multi-rotor aircraft comprising the steps of: determining the thrust levels of a at least two rotors of the multi rotor aircraft; determining the variation in thrust levels between at least two rotors; comparing the variation in thrust against a pre-defined acceptable value for the variation in thrust; adjusting the location of at least one of the rotors relative to at least one other rotor based on the variation in thrust; and adjusting the thrust of the rotors in response to the adjustment of location of the at least one rotor; wherein the aforementioned steps are repeated in sequence until the variation in thrust is within the pre-defined acceptable range whilst also maintaining the distance between the centre of pressure and the centre of gravity of the multi-rotor aircraft within a pre-defined acceptable range.

Preferably, the method further comprising the initial steps of: inputting pre-flight data in relation to the weight of passengers, cargo and/or fuel into a flight management unit; calculating the weight of the multi-rotor aircraft and the centre of gravity thereof based on the inputted pre-flight data; adjusting the location of at least one of the rotors relative to at least one other rotor such that distance between the centre of pressure and centre of gravity of the multi-rotor aircraft is within the pre-defined acceptable limit and the variation in thrust between rotors is within a pre-defined acceptable limit.

Ideally, the method further comprises the step of comparing the weight of the multi-rotor aircraft with a pre-defined maximum take-off weight and preventing flight if the weight of the multi-rotor aircraft exceeds the pre-defined maximum take-off weight.

Preferably, the method further comprising the step of determining, based on the weight of the multi-rotor aircraft and the position of the centre of gravity, whether any possible adjustment of the at least one of the rotors relative to at least one other rotor would result in the distance between the centre of pressure and centre of gravity of the multi-rotor aircraft being within the pre-defined acceptable limit and the variation in thrust between rotors being within a pre-defined acceptable limit, and preventing flight if such an adjustment would not result in this criteria being met.

Ideally, the method further comprises the step of neglecting or subtracting the thrust of any rotor which is attributable to a required flight manoeuver when determining the variation in thrust.

Preferably, a required flight manoeuvre is defined as a selective pitch, roll, yaw, or any other such flight manoeuvre.

Preferably, the storage medium is a computer-readable medium comprising non-transitory instructions storable thereon executable to preform the steps of the method for controlling a multi-rotor aircraft.

### BRIEF DESCRIPTION OF THE DRAWINGS

FIG. 1 is a top view of a multi-rotor aircraft according to the disclosure;

FIG. 2 is a sectional view of an extensible arm of an apparatus for control of a multi-rotor aircraft according to the disclosure;

FIG. 3 is a process flow chart illustrating the steps in a method for controlling a multi-rotor aircraft according to the disclosure;

FIG. 4 is a process flow chart showing the feedback loop employed in a method for controlling a multi-rotor aircraft according to the disclosure;

FIG. 5 is a side view of a multi-rotor aircraft comprising the disclosure;

FIG. 6 is a process flow chart showing the detailed steps of a portion of the method for controlling a multi-rotor aircraft according to the disclosure; and

FIG. 7 is a schematic diagram of a Flight Management Unit which forms part of apparatus and method for control of multi-rotor aircraft.

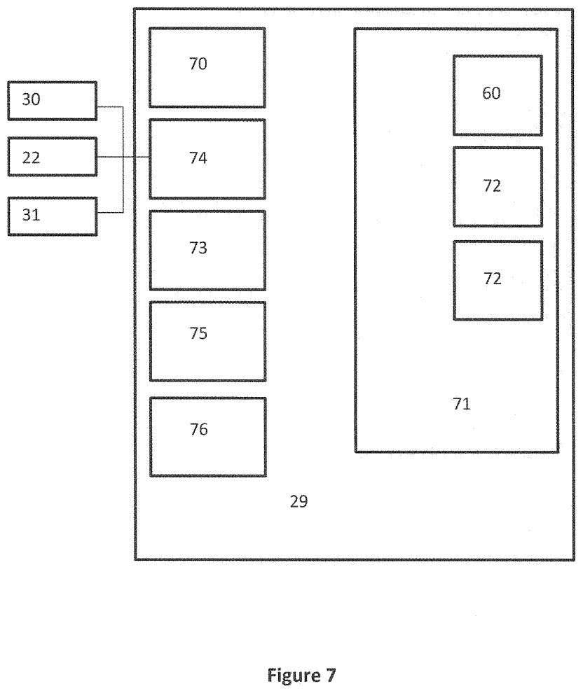

### DETAILED DESCRIPTION OF THE DRAWINGS

The present teaching will now be described with reference to an exemplary apparatus and method for the control of multi-rotor aircraft. It will be understood that the exemplary apparatus and method is provided to assist in an understanding of the present teaching and are not to be construed as limiting in any fashion. Furthermore, elements or components that are described with reference to any one Figure may be interchanged with those of other Figures or other equivalent elements without departing from the spirit of the present teaching.

Referring now to the accompanying drawings, there is illustrated an apparatus for improving control of multi-rotor aircraft comprising a rotor arrangement 10 having a plurality of rotors 11, each rotor being located on a rotor arm 12. The forward and rear arms 13, 14 are extensible arms 13, 14 having rotor actuators 15 such that the rotors of the forward and rear arms are movable rotors 16. The rotor actuators 15 are configured to move the movable rotors 16 relative to the other movable rotors 16 and fixed rotors 18 of the rotor arrangement 10 such that the location of the centre of pressure of the rotor arrangement 10 is adjusted relative to the centre of gravity of an associated multi-rotor aircraft 17. The centre of pressure and centre of gravity of the aircraft 17 may therefore be aligned, or moved to within an acceptable distance of each other such that a variance in thrust between rotors 11 is not required to facilitate such alignment or movement. As thrust variances are not required to balance the aircraft 17, the same margin of additional thrust is maintained for each of the rotors 11, which results in an unrestricted control margin of the entire aircraft 17. This is an important advantage as, where variance in thrust is utilised to balance the aircraft 17, one or more rotors may be at maximum thrust just to preform the task of balancing, meaning that should a flight manoeuvre be required that requires an increase in thrust, these rotors cannot contribute as an increase in thrust is not possible.

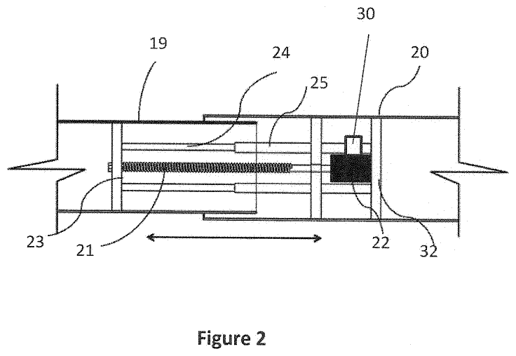

The rotors 11 of the rotor arrangement 10 are arranged in a generally horizontal rotor plane such that the axes of rotation of each of the rotors 11 is generally vertical and perpendicular to the rotor plane. The movement of the movable rotors 16 occurs generally in plane with the rotor plane. As best viewed in FIG. 2, the rotor actuator 15 of the extensible arms 13, 14 has a first portion 19 in operable engagement with a movable rotor 16 and a second portion 20 in engagement with a multi-rotor aircraft 17. The second portion 20 is receivable into the first portion 19 in a telescoping arrangement and the two portions are in movable engagement with each other via a screw 21. It should be appreciated that the arrangement would be easily adapted such that the first portion 19 is receivable into the second portion 20. The screw 21 is in operable engagement with a drive 22 which is mounted to the first portion 19 of an extensible arm and is configured to drive axial rotation of the screw 21. In a preferred embodiment the drive 22 is a servomotor 22 mounted on a flange 32 of the first portion 19, and the screw 20 is an infinite screw. The second portion 20 of the extensible arm has a screw receiving member 23 mounted therein which has a complimentary thread configured to receive the screw 21. The complimentary thread is configured such that rotation of the screw 21 within the complementary thread causes axial movement of the screw 21 through the screw receiving member 23, which in turn causes movement of the first portion 19 of the extensible arm towards or away from the second portion 20 in the axial direction of the screw. The direction of rotation of the screw may be changed such that the axial movement of the first portion 19 may be in either direction, and as such may act to extend or retract the extensible arm. The first and second portions 19, 20 of the extensible arm are generally tubular portions and the screw 21 is mounted therewithin coaxially with the axis of the tubular first and second portions 19, 20. The first and second portions 19, 20 of the extensible arms have two pairs of cooperating guides 24, 25 for guiding the relative movement therebetween and ensuring structural rigidity.

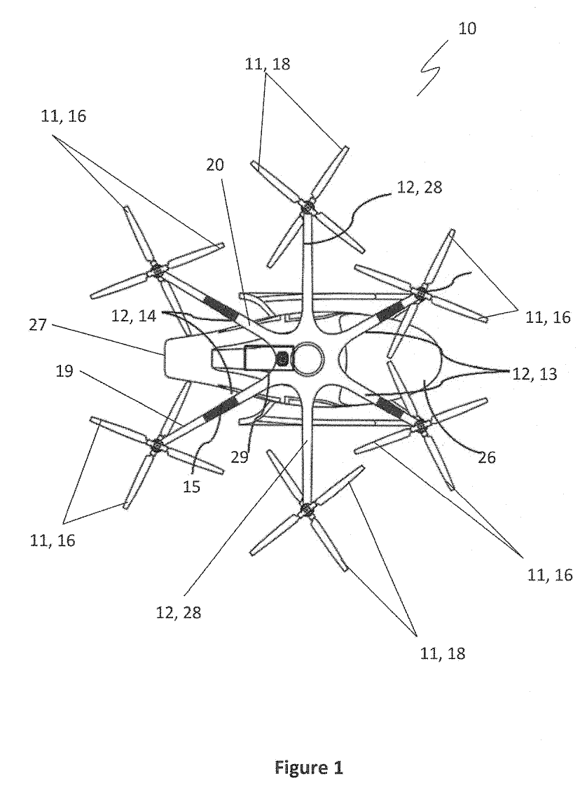

In the embodiment as shown in the drawings, and in particular referring to FIG. 1, the apparatus comprises twelve rotors 11 arranged coaxially in groups of two, each group of two being locatable on an arm 12. The arms 12 extend from a coaxial hub 25 and form a spaced apart arrangement wherein each arm 12 is approximately 60 degrees from adjacent arms. There are two forward arms 13 which project generally forwards from the coaxial hub 25 towards a front end 26 of the multi-rotor aircraft 17. There are also two rear arms 14 which project generally backwards from the coaxial hub 25, towards a back end 27 of the multi-rotor aircraft 17. The remainder of the arms 28 are arms of fixed length.

The apparatus further comprises a flight management unit (FMU) 29 configured to control the rotor actuators 15 and hence the location of the movable rotors 16. The FMU 29 comprises a processor 70 and a memory module 71 which has software stored thereon, the software being executable by the processor. One or more software modules 72 may be encoded in the memory module 71. The software modules 72 may comprise one or more software programs or applications having computer program code or a set of instructions configured to be executed by the processor 70. Such computer program code or instructions for carrying out operations for aspects of the systems and methods disclosed herein may be written in any combination of one or more programming languages.

The software modules 72 may include a control module 60 and one or more additional applications configured to be executed by the processor 70. During execution of the software modules 72, the processor 70 configures the FMU 29 to perform various operations relating to effecting control of the multi-rotor aircraft of the present disclosure.

Other information and/or data relevant to the operation of the present systems and methods, such as a database 73, may also be stored on the memory module 71. The database 73 may contain and/or maintain various data items and elements that are utilized throughout the various operations of the control of the multi-rotor aircraft 50. It should be noted that although the database 73 is depicted as being configured locally to the FMU 29, in certain implementations the database 73 and/or various other data elements stored therein may be located remotely. Such elements may be located on a remote device or server—not shown, and connected to the FMU 29 through a network in a manner known to those skilled in the art, in order to be loaded into a processor and executed.

Further, the program code of the software modules 72 and one or more computer readable storage devices (such as the memory module 71) form a computer program product that may be manufactured and/or distributed in accordance with the present disclosure, as is known to those of skill in the art.

The communication interface 74 is also operatively connected to the processor 70 and may be any interface that enables communication between the FMU 29 and external devices, machines and/or elements including the encoder 30, drive 22, and thrust level sensors 31. The communication interface 74 is configured for transmitting and/or receiving data. For example, the communication interface 74 may include but is not limited to a wired communication interface, Bluetooth, cellular transceiver, a satellite communication transmitter/receiver, an optical port and/or any other such interfaces for wired or wireless connection of the FMU 29 to any required external devices.

A user interface 75 may also be operatively connected to the processor 70. The user interface may comprise one or more input device(s) such as switch(es), button(s), key(s), and a touchscreen. The user interface 75 functions to allow the entry of data by a pilot or other such user. The user interface 75 functions to facilitate the capture of commands from the user such as commands or settings related to operation of the method of controlling a multi-rotor aircraft as described in this disclosure.

A display 76 may also be operatively connected to the processor 70. The display 76 may include a screen or any other such presentation device that enables the user to view various options, parameters, and results, such as the result of a maximum take-off weight check as described in this disclosure. The display 76 may be a digital display such as an LED display. The user interface 75 and the display 76 may be integrated into a touch screen display. The operation of the FMU and the various elements and components described above will be understood by those skilled in the art with reference to the method and system for effecting control of a multi-rotor aircraft 50.

The rotor actuator 15 has an encoder 30 which is in wired or wireless operable communication with the FMU 29 and continuously transmits to the FMU 29 the position of the second portion 20 of each extensible arm 13, 14 relative to the first portion 19 thereof. This information allows the FMU 29 to calculate the position of each movable rotor 16 via the software which includes instructions for carrying out such a calculation. The FMU is also in wired or wireless operable communication with the drive 22 of the screw 21 such that the FMU 29 may control rotation of the screw 21. The rotors 11 have thrust level sensors 31 in wired or wireless operable engagement therewith which are configurable to measure the trust levels of the rotors 11. The trust level sensors 31 may obtain the thrust level of each rotor by any reasonable means known in the art, such as deriving the thrust from the power consumption of the rotors 11, the rotational speed of the rotors 11, or the like. The thrust level sensors 31 are in operable communication with the FMU 29 such that thrust level information is provided to the FMU 29 by the thrust level sensors 31. Motors which drive the rotors 11 are linked by a distributed propulsion system which is configurable to distribute energy to the rotors 11 such that the thrust of individual rotors 11 may be varied. The thrust of individual rotors 11 may be varied in order to reduce the deviation between the centre of pressure of the rotors and the centre of gravity of the multirotor aircraft to within an acceptable range. Distributed propulsion systems which balance a multi-rotor aircraft are known in this field and as such are not described here in detail. The variation in thrust between rotors 11 balances the rotor arrangement where the centre of pressure of a rotary aircraft 17 is not aligned with the centre of gravity thereof.

The software is executable by the processor to control the drives 22 of the screws 21, rotating one or more of the screws 21, and hence adjusting the position of one or more movable rotors 16 in response to the output of the thrust level sensors 31, and taking into account the current position of the movable rotors 16 as obtainable form the encoder 30. The adjusted position of the movable rotors 16 is such that the thrust level of these rotors 16 is adjusted by the distributed propulsion system in order to balance the aircraft 17 with the rotors in their now adjusted position, bringing the distance between the centre of pressure and the centre of gravity into to an acceptable range or operating envelope. In the most preferred case, the adjustment of the thrust levels of the rotors 11 by the distributed propulsion system is such that variation between the thrust level of the rotors 16 of the forward and rear arms 13, 14 is non-existent. However, in many cases, adjustment is made which brings the variation between the thrust level of the rotors 16 of the forward and rear arms 13, 14 within an acceptable range or operating envelope. The centre of pressure and centre of gravity are misaligned by a maximum of 14%, or maximum distance between the centre of pressure and centre of gravity is approximately 16 centimetres based on a multi-rotor aircraft having arms 12 of approximately 2.45 meters.

The software employs a negative feedback control loop whereby when commanded by the FMU 29 any extension or retraction of the extensible arms is reflected in the redistribution of thrust forces generated by the rotors, until these are equalised or within an acceptable range. Determination of thrust variances between at least two rotors 16 is made followed by small movements of at least one movable rotor 16 in an attempt to reduce these thrust variances. Adjustment of thrust levels to one or more rotor 16 are then made to maintain correct attitude of the aircraft 17 in response to the movement of the at least one rotor 16. The negative feedback control loop involves re-determining the thrust variance, after which the process of moving the at least one rotor 16 and adjusting the thrust levels of the at least one rotor 16 to compensate for the movement is repeated. The feedback loop continues until the thrust variance is within a pre-defined acceptable range or operating envelope. This negative feedback control loop results in the distance between the centre of pressure and the centre of gravity being within its acceptable range or operating envelope, whilst the thrusts of the rotors 16 are balanced such that variance in thrust between the front and rear rotors is also within an acceptable range or operating envelope. The negative feedback loop operates throughout flight duration and seeks to compensate for the changing centre of gravity as the fuel is consumed or payload varies, or to make necessary adjustments to the position of the centre of pressure in order to compensate any constant differences between the thrusts of the rotors 11. The stability of the aircraft is enhanced and fuel consumption is reduced due to the balanced thrust in the rotors 11. In addition, increased flight time is accommodated by ensuring that a large enough quantity of fuel may be stored on-board the aircraft 17 whilst accounting for the effect of fuel consumption on the centre of gravity.

The apparatus raises the safety level of multirotor aircraft operation, by ensuring that the centre of gravity is placed within a safety range, or by prohibiting the use of the aircraft when the centre of gravity exceeds these limits. Furthermore, an additional advantage is maximizing the operating margin and the efficiency of multirotor aircraft by superposing the centre of gravity and the centre of pressure, thus eliminating the disadvantages of operating the aircraft 17 when the centre of gravity is forward or aft, or towards the safety limits.

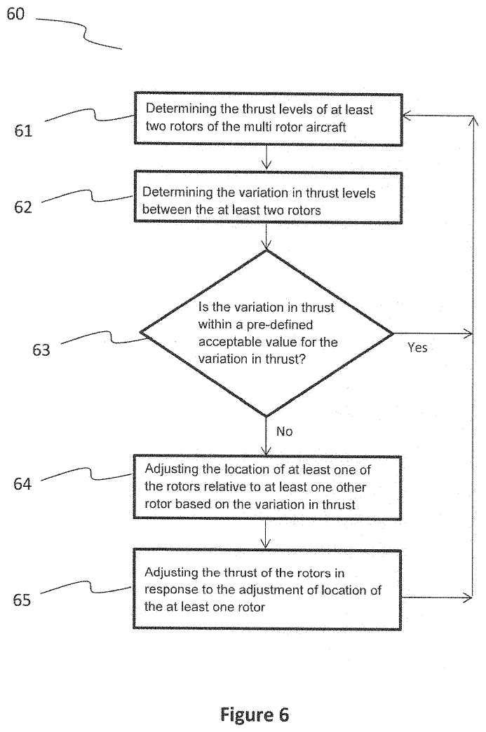

In use, a method for improving control of a multi-rotor aircraft 17 is shown in FIG. 6 and comprises determining the thrust levels of the rotors 16 of the forward and rear arms 13, 14 of the multi rotor aircraft 17, step 61, and determining the variation in thrust levels between the rotors of the forward and rear arms 13, 14, step 62. The method then involves comparing the variation in thrust against a pre-defined acceptable value for the variation in thrust, step 63, and thereafter, if the variation in thrust is not less than this pre-defined acceptable value, adjusting the location of one or more of the rotors of the forward and rear arms 13, 14 relative to each other based on the variation in thrust such that the variation in thrust is reduced, step 64. The distributed propulsion system then adjusts the thrust of the one or more of the rotors 16 of the forward and rear arms 13, 14 in response to the adjustment of the location thereof, step 65. These steps are repeated until the variation in thrust is within the pre-defined acceptable range whilst also maintaining the distance between the centre of pressure and the centre of gravity of the multi-rotor aircraft 17 within a pre-defined acceptable range. Where assessing variance in thrust, it is important to note that trust in any rotor 16 which is attributable to a required flight manoeuver is neglected or subtracted from the thrust level value of said rotor 16. A required flight manoeuvre is generally a selective pitch, roll, yaw, or any other such flight manoeuvre.

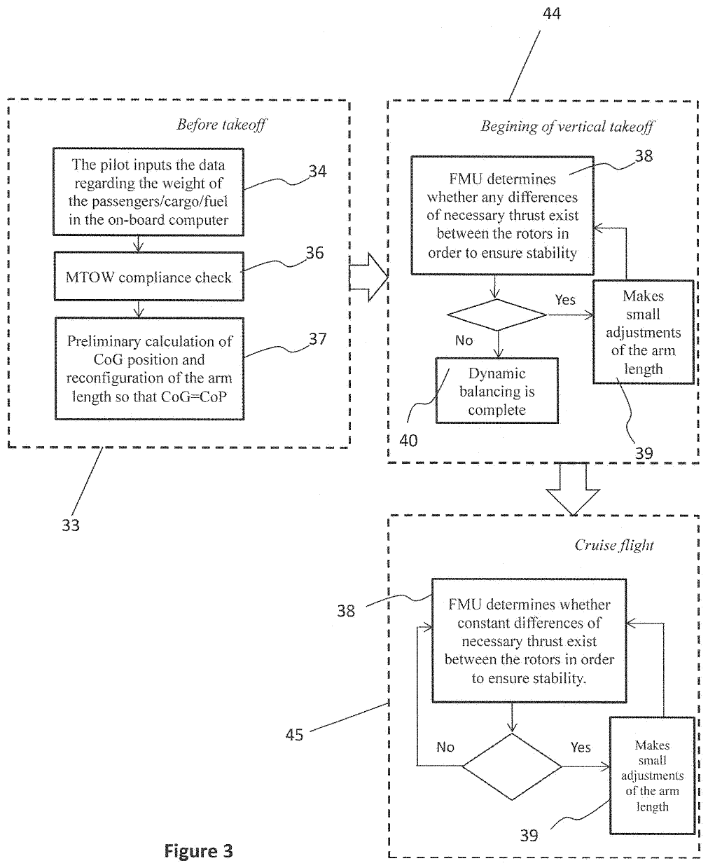

In addition, as shown in FIG. 3, the method comprises an initial pre-flight phase 33 which is begun by inputting pre-flight data in relation to the weight of passengers, cargo and/or fuel into a flight management unit (FMU) 29, step 34. The weight of the multi-rotor aircraft is then calculated by the FMU 29 as is the centre of gravity thereof based on the inputted pre-flight data. The location of one or more of the rotors 16 of the forward and rear arms 13, 14 is adjusted such that the distance between the centre of pressure and centre of gravity of the multi-rotor aircraft 17 is within the pre-defined acceptable limit and the variation in thrust between rotors 16 is within a pre-defined acceptable limit. After comparing the weight of the multi-rotor aircraft 17 with a pre-defined maximum take-off weight, step 36, flight is prevented if the weight of the multi-rotor aircraft 17 is in excess of a pre-defined maximum take-off weight. Similarly, based on the weight of the multi-rotor aircraft 17 and the position of the centre of gravity, it is determined whether any possible adjustment of one or more of the rotors 16 of the forward and rear arms 13, 14 would result in the distance between the centre of pressure and centre of gravity of the multi-rotor aircraft 17 being within the pre-defined acceptable limit and the variation in thrust between rotors being within a pre-defined acceptable limit. If such adjustments would not result in these criteria being satisfied, flight is prevented. This leads to increased operational safety of the aircraft 17, by avoiding any possible errors made by the pilot when estimating mass of the passengers, baggage, or fuel, or by exceeding the maximum weight at take-off. During the initial pre flight phase, the FMU carries out the preliminary calculation for adjusting the length of the forward and rear arms 13, 14, executes these adjustments by controlling the drives 22 of the relevant arm actuators 15 before take-off, step 37, and confirms that this task has been accomplished to the pilot via the display 76.

The adjustment process continues in a phase immediately after take-off, see block 44, as the FMU 29 analyses the existence of any difference between the thrusts of the front and rear rotors 16, step 38, and commands the execution of corresponding small adjustments, step 39, by controlling the drives 22 of the relevant arm actuators 15 until the thrust differences between the rotors 16 are reduced to a very small interval by the distributed propulsion system, at which point the balancing is complete, step 40. The balancing process during take-off is done in very low altitude flight, lasts several seconds and ensures the exact determination of the masses within the aircraft 17. In cruise flight, see block 45, a similar process continues wherein steps 38 and 39 as described hereinbefore are repeated such that the necessary adjustments are made to maintain stability.

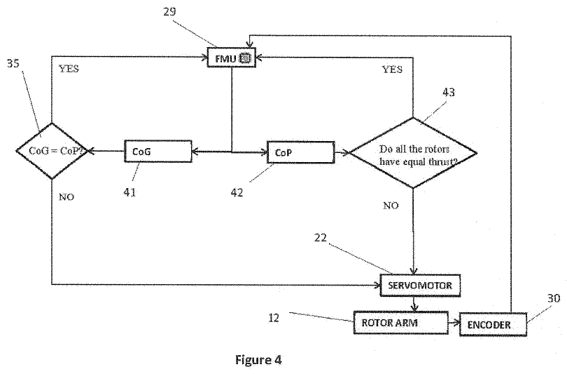

FIG. 4 depicts the interaction between the components that dynamically control the length of the rotor arms 13, 14 so that the centre of pressure in relation to the centre of gravity is within operational limits both at take-off and during the whole flight. In one branch of the diagram the FMU 29 performs a check through a centre of gravity (CoG) module 35, in order to ascertain whether the centre of gravity 41 is within operational limits with regards to the centre of pressure 42. If the result is negative, the FMU 29 executes adjustments to the length of the rotor arms 13, 14 until the situation is resolved. In the other branch of the diagram, see block 43, the FMU detects differences between the thrusts generated by the rotors 16 of the forward and rear arms 13, 14 of the aircraft 17. Differences attributed to flight manoeuvres are neglected or subtracted form the determination of the thrust level for the purposes of comparison. If any such differences are found, the FMU 29 executes small suitable adjustments until these differences are eliminated, as facilitated by the negative feedback loop previously described herein.

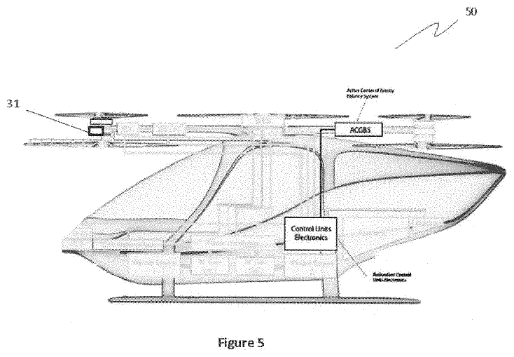

FIG. 5 illustrates the integration of the apparatus in a VTOL multi-copter 50 which can transport 2-5 persons along with their cargo. The multi-copter 50 may be fully autonomous or semi-autonomously manned. It may feature a fully electrical propulsion system, for example comprising 12 propellers turned by 12 electrical motors, and in operation is safer, more versatile, and significantly more silent than a traditional helicopter. In fully autonomous mode, the pilot may choose the flight route from point A to point B, as the FMU 29 will calculate, by execution of software thereof, a virtual route and handle control of the aircraft 50 for the flight in its entirety. In manual flight mode the pilot may command the flight behaviour just by using a joystick (throttle up/down, pitch forward/back, roll left/right, yaw left/right). The concerns of piloting a conventional rotary aircraft such as maintaining a correct flight attitude, safety speed, etc. may no longer be of concern as all the flight commands will be handled by the FMU 29. The software of the FMU is also configured to analyse and correct any wrong command and ensure a fully controlled and safe flight. The power train may consist of two thermic Wankel engines attached to two AC Generator Sets. The secondary system, ensuring redundancy, may consist of a Li—Po Battery pack, ensuring 15 minutes or more of safe flight in case of main engines failure. The propulsion may, for example, be ensured by 12 propellers and 12 electrical motors each having a 15 Kw power rating. Thus the multi-copter will feature a robust design with very few moving parts, as no transmission and linkage mechanisms will be required. All the essential components will be redundant, ensuring an extremely reliable and safe aircraft. The presented multi-copter reaches standards comparable to that of traditional aircraft, owing to its extended flight time and safe design.

In summary, major advantages of the above described system and method are dynamic adjustment of the position of the centre of pressure in relation to the centre of gravity of the aircraft, significantly increasing its flight stability; balanced thrust between rotors during operation, as the compensation for a displaced centre of gravity relative to the centre of pressure, which would require generating different thrusts between the rear and front rotors, is no longer necessary; it ensures that the same margin of additional power is maintained for each of the rotors, which results in an unrestricted control margin of the entire aircraft; and it significantly raises the operational safety of the aircraft by avoiding possible errors made by the pilot when estimating mass of the passengers, baggage, etc. or by exceeding the maximum weight at take-off.

It will be understood that while exemplary features of an apparatus for control of multi-rotor aircraft have been described that such an arrangement is not to be construed as limiting the invention to such features. The method for controlling a multi-rotor aircraft may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method for controlling a multi-rotor aircraft. The processor(s) is a hardware device for executing software, particularly software stored in memory. Processor(s) can be any custom made or commercially available processor, a primary processing unit (CPU), an auxiliary processor among several processors associated with a computer, a semiconductor based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this disclosure, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing throughput and reducing processing requirements.

The invention is not limited to the embodiment(s) described herein but can be amended or modified without departing from the scope of the present invention.

1. An apparatus for control of multi-rotor aircraft comprising:
at least one rotor movement means in operable engagement with at least one movable rotor of a rotor arrangement;
wherein the rotor movement means is configured to move the movable rotor in operable engagement therewith relative to at least one other rotor of the rotor arrangement such that the location of the centre of pressure of the rotor arrangement is adjusted relative to the centre of gravity of an associated multi-rotor aircraft.

2. The apparatus of claim 1, wherein there are multiple rotor movement means, each in operable engagement with at least one movable rotor, each rotor movement means being configured to move its respective at least one movable rotor relative to other movable rotors, and/or relative to at least one fixed rotor of the rotor arrangement.

3. The apparatus of claim 1, wherein the rotor movement means is an extensible arm having a first portion in operable engagement with a movable rotor and a second portion in engagement with a multi-rotor aircraft or component thereof, the first portion and second portion being engagable with each other in a manner which permits relative movement therebetween.

4. The apparatus of claim 3, wherein the first portion and the second portion of the extensible arm are engagable with each other via a screw means.

5. The apparatus of claim 4, wherein the screw means is in operable engagement with a drive means, the drive means being configured to drive axial rotation of the screw means.

6. The apparatus of claim 5, wherein the drive means is mountable to the first portion of the extensible arm and the second portion of the extensible arm comprises screw engagement means attachable thereto or integratable therewith.

7. The apparatus of claim 6, wherein the screw engagement means comprises a complimentary thread configured to receive the screw, the complimentary thread being configured such that rotation of the screw within the complementary thread causes movement of the first portion of the extensible arm towards or away from the second portion of the extensible arm and generally axially along the screw.

8. The apparatus of claim 3, wherein the first and/or second portions of the extensible arm comprise guide means for guiding the relative movement therebetween.

9. The apparatus of claim 3, wherein the first and second portions of the extensible arm are configured in a telescoping arrangement such that one of the portions is movably mountable within the other portion.

10. The apparatus of claim 1 comprising twelve rotors arranged coaxially in groups of two, each group of two being locatable on an arm, the arms extending from a coaxial hub and form a spaced apart arrangement, each arm being approximately 60 degrees from adjacent arms.

11. The apparatus of claim 10, wherein two of the arms are forward arms which project generally forwards from the coaxial hub, towards a front end of a multi-rotor aircraft to which they are attached.

12. The apparatus of claim 10, wherein two of the arms are rear arms which project generally backwards from the coaxial hub, towards a back end of a multi-rotor aircraft to which they are attached.

13. The apparatus as claimed in claim 11, wherein the forward arms and the rear arms comprise rotor movement means such that the rotors associated therewith are movable rotors, the remainder of the arms being arms of fixed length.

14. The apparatus of claim 1, wherein the apparatus further comprises a control means configured to control the rotor movement means or a component thereof.

15. The apparatus of claim 14, wherein the rotor movement means have location detection means in operable engagement therewith configurable to determine the location of the movable rotors.

16. The apparatus of claim 14, wherein thrust level sensors are in operable engagement with the rotors, or in operable engagement with drive means of the rotors, the thrust level sensors being configurable to measure the trust levels of the rotors.

17. The apparatus of claim 14, wherein the rotors are driven by motors, the motors being linked by a distributed propulsion system which is configurable to distribute energy to the rotors such that the thrust of individual rotors may be varied in order to reduce the deviation between the centre of pressure of the rotors and the centre of gravity of the multirotor aircraft to within an acceptable range.

18. The apparatus of claim 17, wherein the variation in thrust between rotors balances the rotor arrangement where the centre of pressure of a rotary aircraft is not aligned with the centre of gravity thereof.

19. The apparatus of claim 17, wherein the control means comprises a processor and a storage medium, the storage medium having software storable thereon which is executable by the processor to control the rotor movement means or a component thereof.

20. The apparatus of claim 19, wherein the control means is in operable communication with the rotor movement means or a component thereof and in operable communication with the location detection means and the thrust level sensors, the software being configured to adjust the position of at least one of the movable rotors in response to the output of the thrust level sensors and/or the location detection means.

21. The apparatus of claim 20, wherein the software is configured to adjust the position of the movable rotors such that the thrust level of at least one rotor is adjusted by the distributed propulsion system and thus variation between the thrust level of at least two rotors is zero, or at least falls within an acceptable range.

22. The apparatus of claim 20, wherein the software is configured to adjust the position of the movable rotors such that the distance between the centre of pressure and the centre of gravity is zero, or at least falls within an acceptable range.

23. A multi-rotor aircraft comprising an apparatus for improving control, the apparatus further comprising:
a rotor arrangement comprising a plurality of rotors;
at least one rotor movement means in operable engagement with at least one movable rotor;
wherein the rotor movement means is configured to move the at least one movable rotor in operable engagement therewith relative to at least one other rotor of the rotor arrangement such that location of the centre of pressure of the rotor arrangement is adjusted relative to the centre of gravity of the multi-rotor aircraft.

24. A method for controlling a multi-rotor aircraft comprising the steps of:
determining the thrust levels of at least two rotors of the multi rotor aircraft;
determining the variation in thrust levels between the at least two rotors;
comparing the variation in thrust against a pre-defined acceptable value for the variation in thrust;
adjusting the location of at least one of the rotors relative to at least one other rotor based on the variation in thrust; and
adjusting the thrust of the rotors in response to the adjustment of location of the at least one rotor;
wherein the aforementioned steps are repeated in sequence until the variation in thrust is within the pre-defined acceptable range whilst also maintaining the distance between the centre of pressure and the centre of gravity of the multi-rotor aircraft within a pre-defined acceptable range.

25. The method of claim 24, further comprising the initial steps of:
inputting pre-flight data in relation to the weight of passengers, cargo and/or fuel into a flight management unit;
calculating the weight of the multi-rotor aircraft and the centre of gravity thereof based on the inputted pre-flight data;
adjusting the location of at least one of the rotors relative to at least one other rotor such that distance between the centre of pressure and centre of gravity of the multi-rotor aircraft is within the pre-defined acceptable limit and the variation in thrust between rotors is within a pre-defined acceptable limit.

26. The method of claim 25, further comprising the step of comparing the weight of the multi-rotor aircraft with a pre-defined maximum take-off weight and preventing flight if the weight of the multi-rotor aircraft is in excess of the pre-defined maximum take-off weight.

27. The method of claim 25, further comprising the step of determining, based on the weight of the multi-rotor aircraft and the position of the centre of gravity, whether any possible adjustment of the at least one of the rotors relative to at least one other rotor would result in the distance between the centre of pressure and centre of gravity of the multi-rotor aircraft being within the pre-defined acceptable limit and the variation in thrust between rotors being within a pre-defined acceptable limit, and preventing flight if such an adjustment would not result in this criteria being met.

28. The method of claim 25, further comprising the step of neglecting or subtracting the thrust of any rotor which is attributable to a required flight manoeuver when determining the variation in thrust.

29. A computer-readable medium comprising non-transitory instructions which, when executed, cause a processor to carry out a method according to claim 24.
